(19) United States
(12) Patent Application Publication
(10) Pub. No.: US 2006/0136966 A1
(43) Pub. Date: Jun. 22, 2006

(54) Digital video recorder for recording missed program episodes and for resolving scheduling conflicts between programs to be recorded

(76) Inventor: Robert H. Folk II, Narberth, PA (US)

Correspondence Address: MAYER & WILLIAMS PC, 251 NORTH AVENUE WEST, 2ND FLOOR, WESTFIELD, NJ, 07090, US

(21) Appl. No.: 11/019,790

(22) Filed: Dec. 22, 2004

(51) Int. Cl. H04N 7/173; H04N 5/445; H04N 7/16; H04N 5/91; G06F 13/00; G06F 3/00

(52) U.S. Cl. 725/58; 386/46; 725/46; 725/134; 725/142

(57) ABSTRACT

A method and apparatus is provided for recording at least one program received over a broadband communications system. The method begins by accessing a database that includes program information that describes with program attributes a plurality of programs available over the broadband communications system. User-defined criteria are received that identify preferred program attributes. The database is sorted through to identify at least one preferred program having program attributes that include the preferred program attributes. From information in the database a first scheduled time at which the preferred program is to be received is identified. The first scheduled time is compared to another scheduled time of another program to be recorded. If the first scheduled time and the other scheduled time overlap in whole or in part, thereby giving rise to a scheduling conflict, the method continues by sorting through the database to identify a second scheduled time at which either the preferred program or the other program is available. Recording is then scheduled at the second scheduled time of either the preferred program or the other program that is available at the second scheduled time. Recording is next scheduled of a remaining one of the preferred program or the other program at the first scheduled time or the other scheduled time, respectively.

### FIELD OF THE INVENTION

The present invention relates generally to recording devices employed in a communications system and more specifically to a method and apparatus for scheduling and recording programs broadcast over a broadband communications system.

### BACKGROUND OF THE INVENTION

A conventional system for displaying a program, e.g., a video program, includes a monitor or a television (TV) set connected to a set top box. The set top box is connected through a coaxial cable to a cable TV network or a satellite dish for “satellite TV.” The TV set and the set top box are located, for example, in a user's home and receive a multitude of TV channels from a broadcast head end, wherein each TV channel has a multitude of programs during a typical day. In order to select and watch a certain program, the user controls the set top box to tune to a desired channel. The TV set receives a video signal from the set top box and displays the program of the desired channel.

A user may expand the system by connecting a video recorder to the TV set and the set top box to personalize television viewing by recording a program on a digital video recorder (DVR) and watching it when it is convenient for the user. For example, a prior art DVR allows a user to not only record his/her favorite TV programs for later review, but also to exercise a season-pass-like option to record every episode of his/her favorite program for a period. It may automatically record programs for the user based on his/her viewing habits and preferences. The presentation of the recorded programming content can be manipulated by exercising such functions as rewind, pause and fast-forward.

DVRs often enhance a television viewer's experience by employing one or more Electronic Program Guides (EPGs). As known in the art, the electronic program guide lists scheduled programs for a predetermined period of time (e.g., two weeks) and provides, among others, information about broadcast dates and times and content information. For example, the program attributes may include the content information, which describes for each program the channel, actor, director, title, genre, language and the like. With an EPG, television viewers navigate through an onscreen program guide to locate programming. Typically viewers browse the guide or query it. With a guide, viewers browse currently available programming and schedules of programming available in the future. By using keywords or categories, viewers typically search the guide for programming. With an EPG, the viewers may also set reminders for upcoming programs or enter instructions to record one or more shows.

Recently, some set-top terminals for cable TV were improved to incorporate the above-described DVR functions (“DVR set-top terminals”). For example, like a DVR, a DVR set-top terminal typically includes a hard drive, e.g., a disk, for digitally recording TV programs, in accordance with the DVR functions.

Although DVRs and DVR set-top terminals enable users to specify the recording time, channel, and duration for a plurality of events, it cannot meet the increasing needs in defining and capturing the program events in a more intelligent way. For instance, in situations where there is a scheduling conflict between two programs that are to be recorded, the devices cannot automatically resolve the problem in a way that allows both programs to be recorded, if at all possible.

### SUMMARY OF THE INVENTION

In accordance with the present invention, a method and apparatus is provided for recording at least one program received over a broadband communications system. The method begins by accessing a database that includes program information that describes with program attributes a plurality of programs available over the broadband communications system. User-defined criteria are received that identify preferred program attributes. The database is sorted through to identify at least one preferred program having program attributes that include the preferred program attributes. From information in the database a first scheduled time at which the preferred program is to be received is identified. The first scheduled time is compared to another scheduled time of another program to be recorded. If the first scheduled time and the other scheduled time overlap in whole or in part, thereby giving rise to a scheduling conflict, the method continues by sorting through the database to identify a second scheduled time at which either the preferred program or the other program is available. Recording is then scheduled at the second scheduled time of either the preferred program or the other program that is available at the second scheduled time. Recording is next scheduled of a remaining one of the preferred program or the other program at the first scheduled time or the other scheduled time, respectively.

In accordance with one aspect of the invention, the other program to be recorded is identified simultaneously with the preferred program.

In accordance with another aspect of the invention, the other program to be recorded has been scheduled for recording prior to identifying the preferred program.

In accordance with another aspect of the invention, the database is an electronic program guide.

In accordance with another aspect of the invention, the identifying, comparing and scheduling steps are performed by a digital video recorder.

In accordance with another aspect of the invention, the identifying, comparing and scheduling steps are performed by a set-top terminal that incorporates a digital video recorder.

In accordance with another aspect of the invention, a determination is made whether the preferred program is an episode in a series of related programs to be recorded. The database is sorted through to identify any unrecorded episodes of the series of related programs that have been previously made available over the broadband communications system. From information in the database other scheduled times are identified at which one or more of the unrecorded, previously available episodes will again be available. Recording of the unrecorded, previously available episode(s) is scheduled at one of the other scheduled times.

In accordance with another aspect of the invention, an apparatus is provided that includes a receiver/tuner for receiving programming content over a broadband communications system and a decoder for decoding programming content provided by the receiver/tuner. An electronic storage device electronically stores selected content received over the broadband communications system. A database is also provided to which an electronic program guide is periodically downloaded from a remote location. A control unit is operationally associated with the receiver/tuner, the decoder, the electronic storage device and the database. A user interface is operationally associated with at least the control unit and the database. The control unit is configured to (i) determine whether a scheduling conflict arises between or among two or more programs to be received over the broadband communications system and scheduled for recording onto the electronic storage device via the user interface; (ii) identify in the database another time at which one of the two or more programs will be available for receipt over the broadband communications system; and (iii) reschedule for recording at the other time the one program that will be available at that other time.

### BRIEF DESCRIPTION OF THE DRAWINGS

FIG. 1 illustrates a broadband communications system for providing content to a user in accordance with the present invention.

FIG. 2 shows one embodiment of the present invention that is embodied in a DVR-equipped set-top terminal.

FIG. 3 is a flow-chart illustrating one embodiment of the operation of the DVR-equipped set-top terminal of FIG. 2 in accordance with the present invention.

### DETAILED DESCRIPTION

The present invention provides a method and apparatus for performing enhanced recording for content in a communication system. The device may be a set top box (STB) equipped with digital video recording (DVR) capabilities, for example. While the present invention is preferably directed to a STB equipped with a DVR, it is not limited to this configuration. The apparatus and various processes may be embodied in a discrete apparatus such as a DVR player or a TV/DVR composite structure, or it may be distributed over a network with any combination of hardware, firmware, and software.

As detailed below, the present invention overcomes the aforementioned limitations of conventional devices that have DVR capabilities by automatically resolving a scheduling conflict between two programs that are to be recorded. Specifically, the present invention postpones recording of one of the programs if that program will be rebroadcast at a later time. In this case the device automatically reschedules the recording of the program for the date, time and channel of the rebroadcast. In addition to resolving scheduling conflicts, the invention can also automatically schedule and record previously broadcast episodes that belong to a series of programs that are to be recorded at a date and time when they will be rebroadcast.

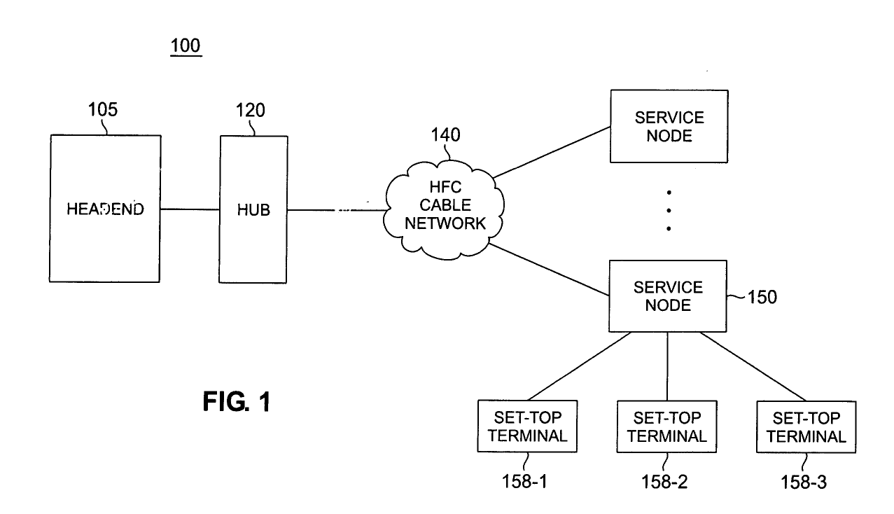

FIG. 1 illustrates broadband communications system 100 for providing content to a user. System 100 in this instance includes a cable system for delivering information and entertainment programs to set-top terminals on the user premises. As shown in FIG. 1, system 100 includes headend 105, hub 120, hybrid fiber coax (HFC) cable network 140 and different service area nodes including node 150, which in this instance is connected to set-top terminals 158-1 through 158-3 in a neighborhood or other limited geographic region.

Headend 105 receives programs and services from various providers and sources, e.g., analog and digital sources, application servers, the Internet, etc. Analog and digital sources typically provide the traditional forms of television broadcast programs and information services. Application servers typically provide executable code and data for application specific services. Although specific examples of programs and services which may be provided by the aforementioned sources are given herein, other programs and services may also be provided by these or other sources.

Headend 105 processes program materials including, e.g., TV program streams, from one or more of the aforementioned sources in analog and digital forms. Analog TV program streams may be formatted according to the National Television Standards Committee (NTSC) or Phase Alternating Line (PAL) broadcast standard. Digital TV streams may be formatted according to the Digital Video Broadcasting (DVB), Society of Cable Telecommunications Engineers (SCTE), or Advanced Television Systems Committee (ATSC) standards. Among other things, headend 105 extracts program content in the analog and digital TV streams and reformats the content to form one or more MPEG-2 encoded transport streams. The transport streams may be carried on one or more channels. For example, each channel may be 6 MHz bands populating a forward passband, e.g., 350-750 MHz band, of a coaxial cable, which is allocated for downstream communication from headend 105 to a set-top terminal. Upstream data from a set-top terminal to service node 150 is communicated via a reverse passband, e.g., 5-40 MHz band, of a coaxial cable. The reverse passband comprises reverse data channels (RDCs) having a 1 MHz bandwidth in this instance, through which signals containing upstream data are transmitted. It should be noted that the 1 MHz bandwidth allocated for an RDC here is for illustrative purposes only. It will be appreciated that a person skilled in the art may allocate other bandwidths therefor depending on the actual implementations. Moreover, the various connections and standards discussed above are exemplary only. More broadly, the present invention encompasses any transmission system for delivering information content such as video to a consumer.

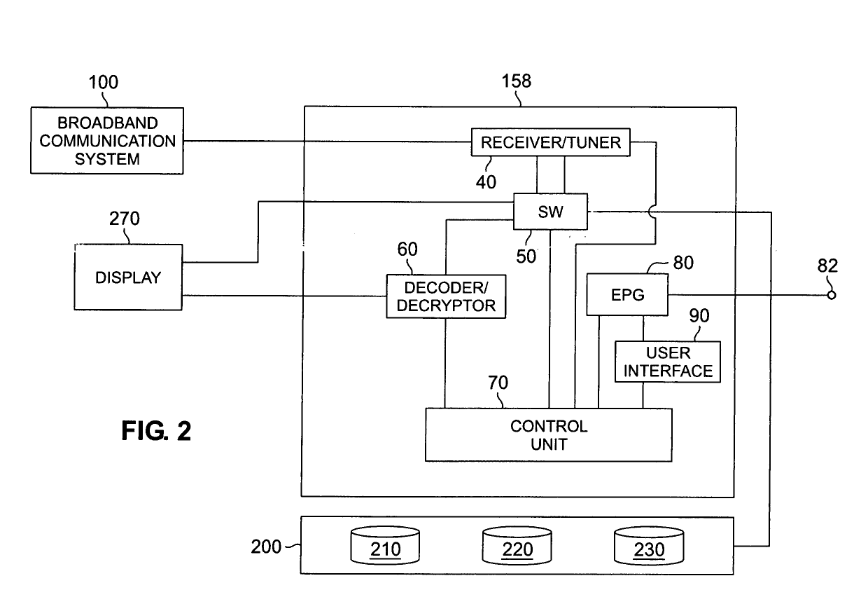

On the consumer side, set top terminal 158 is shown in more detail in FIG. 2. It should be noted that set top terminal 158 more generally may be any apparatus such as a hardware card, specially programmed computer or other device having the functionality described herein that may be placed near to or within a television or other display device (such as a computer monitor) such as display unit 270. The set top terminal 158 receives content from broadband communications system 100 seen in FIG. 1. The received content is fed to receiver/tuner 40. The receiver/tuner 40 provides an appropriate connection to the corresponding communication path. The receiver/tuner 40 may also select or tune a channel within the spectrum of content being fed to the set top box 158. If there is only one channel, then the receiver unit 40 need not include a tuner circuit.

A switch 50 is connected to the receiver/tuner 40 and routes the content to display unit 270, decoder/decrypter 60, or storage device 200. The switch 50 is controlled by control unit 70 to route the content to the desired destination. The decoder/decrypter 60 includes decoder circuitry and/or decryption circuitry. For example, many video broadcasts are encoded and the decoder 60 decodes this encoded content stream so that it may be viewed by the consumer on display unit 270. Conventional decoding processes such as MPEG1 and MPEG2 are examples of such decoding processes.

The decoder/decrypter 60 may also include decryption circuitry that decrypts encrypted content from the content feed. Some broadcasts, particularly pay-per-view broadcasts or premium channels such as HBO™ and Showtime™ are encrypted so that non-subscribers cannot view the content. The decrypter 60 decrypts any such encrypted content for viewing on the display unit 270 by the consumer. The decrypter may include a variety of decryption schemes for corresponding premium channels or services. As with conventional cable boxes, the decryption circuitry may be enabled or disabled depending upon the consumer's subscription to the premium channel or associated encrypted content. Authorization for decryption may be governed by appropriate payment for the associated content. For example, pay-per-view content is typically encrypted with decryption authorization governed by an appropriate payment by the consumer.

The electronic program guide (EPG) 80 is connected to an input port 82 so that updates can be downloaded to it. In other words, the electronic program guide stores available content for the near future. This available content may be updated on a periodic basis so that the consumer can make appropriate selection for upcoming programs. The electronic program guide 80 preferably displays information on the display unit 270. For example, the electronic program guide 80 may display programs in a tabular format by channel and time so that the user can make selections of desired content. The electronic program guide 80 may be downloaded by connecting port 82 to a telephone line, cable connection, satellite up-link, or radio broadcast antenna.

The user interface 90 may include various control devices such as a keypad connected directly to the set top box 158 or a remote control device. The user interface 90 permits the user to interact with the set top box 158 and electronic program guide 80 and thereby select content for recording and on-demand playback.

The storage device 200 is connected to the switch 50 as well as the control unit 70 and the decoder/decrypter 60. The storage device 200 may also be directly connected to the display unit 270. The storage device 200 may include one or more hard disk drives 210, 220, 230. Alternatively, the storage device 200 may include other types of storage devices. For example, the storage device may include solid state memory devices such as chips, cards, or sticks. The storage device may also include magnetic tape, magnetic or optical disk, and the like.

The control unit 70 is connected to the storage devices 200, the decoder/decrypter 60, the switch 50, the receiving device 40, the electronic program guide 80, as well as the user interface 90. In general, the control unit 70 coordinates all of the operations performed by the apparatus 100 by sending appropriate control signals to each of the various components. For example, when the electronic program guide indicates that the desired content will appear on channel 4 at 9:00 pm, the control unit 70 sends a control signal to receiver/tuner 40 to tune channel 4 at 9:00 pm, then control unit 70 sends a control signal to control switch 50 to switch the tuned content and output the tuned content to the storage device 200. The control unit 70 also controls the recording of this content on the storage device 200. For example, the control unit 70 may synchronize the sending/receiving of data between the storage device 200 and the decoder/decrypter 60, in order to avoid periods of inaccessibility. Additionally, any necessary decoding or decryption is controlled by control unit 70, which sends commands to the decoder/decrypter 60, the output of which is sent to display unit 270. The control unit 70 may also be utilized to control the rate at which information is recorded or played back. For example, the control unit 70 may record on a first medium, for example an internal medium, in real time, and then stream the information to a removable medium, either faster or slower than real time, depending on the capabilities of the removable medium. Similarly, the control unit 70 may permit the playback of information from either an internal or external memory, either faster or slower than real time, and subsequently output the data for playback in real time. The control unit 70 may utilize one or more medium to vary the rate at which content is either played back or recorded by utilizing at least one medium as a buffer.

The control unit 70 also coordinates the operations between the user interface 90 and the electronic program guide 80. For example, the on-demand playback of previously recorded content may be controlled with the user interface 90 by having the consumer input a command. This command is received by the control unit 70. For example, a play previously-recorded content command may be input by user interface 90. This command is sent to control unit 70 which activates the storage device 200 to read the corresponding content from the storage device 200. Any necessary decoding is then performed by decoder 60 under the control of control unit 70 the results of which are output to display unit 270.

It will be understood that the functions of the various components of the set-top terminal 158 shown in FIG. 2 may be carried out using hardware, software, firmware, or any combination thereof. That is, the particular functional elements set forth in FIG. 2 are shown for purposes of clarity only and do not necessarily correspond to discrete physical elements.

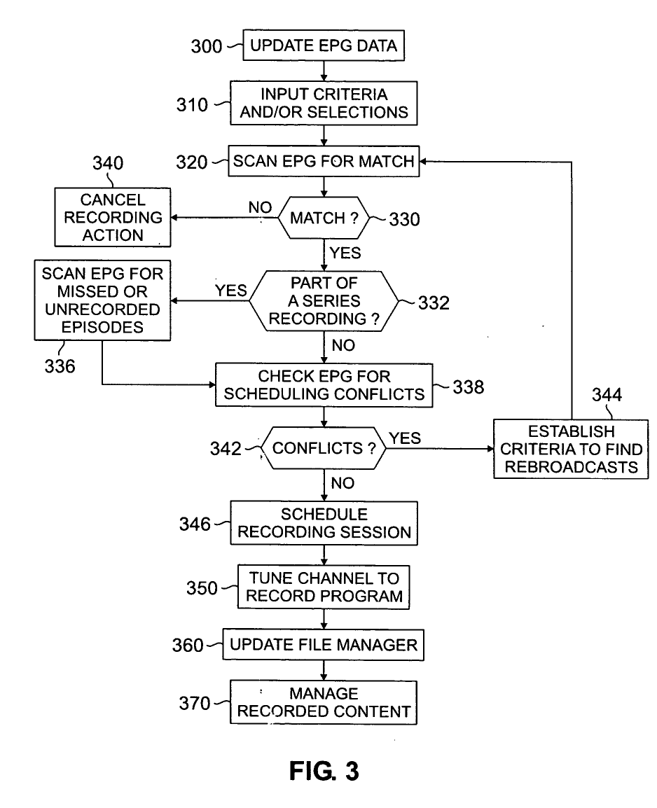

FIG. 3 illustrates further details of how the DVR set-top terminal of FIG. 2 operates in accordance with the present invention. This process begins in step 300 by downloading or updating the electronic program guide 80. This may be done by utilizing port 82. For example, as previously mentioned, port 82 may be connected to a telephone line, cable connection, satellite up-link, or radio broadcast antenna. Using any or all of these methods, the information in the electronic program guide 80 may be down-loaded or updated by step 300. Preferably, in some embodiments of the invention the electronic program guide 80 is updated on a periodic basis. For example, it may be most convenient to update the electronic program guide during off-peak hours. By tracking the user's viewing habits, the system can determine when these off-peak hours occur so that the downloading of the electronic program guide can occur when the consumer is not watching TV.

Step 310 then inputs criteria and/or program selection(s). The consumer can manually input one or more program selections with the user interface 90. To aid in this process, the electronic program guide 80 may send a display to display unit 270 that facilitates the manual input of content selections. In this way, the consumer can designate or otherwise select certain programs or other content to be recorded. Alternatively, the user can enter criteria by which program selections are to be made. Such criteria can include, for example, actors, directors, genre, release date, keywords or other information that is available in the electronic program guide 80 concerning or relating to the content. In this way, the user can manually input one or more selection criteria in order to search for desired content. This search may return a list or group of programs all of which may be recorded or which may be provided to the user for selection where only the selected content is recorded.

With the criteria and/or content selection in hand, step 320 can then scan the electronic program guide 80 for matches. In other words, the available content within the electronic program guide 80 is scanned for content matching the user's selections and/or criteria. Step 330 then determines whether there is a match between the consumer selections and/or criteria and the electronic program guide 80. If there is no match, then the process terminates at step 340. If there is a match between the consumer's selections and/or criteria, then the method proceeds to step 332 which determines if a series of related programming is to be recorded. If no, then the method proceeds to step 338. If a series is in fact to be recorded, then the method proceeds to step 336 in which the electronic program guide 80 is scanned to determine if there are any unrecorded episodes of the series that will be rebroadcast at a later time. The determination of whether a given episode is unrecorded may be performed in a variety of different ways. For example, the control unit 70 may insert a flag or other identifier in the program guide data indicating that a program is scheduled to be recorded. In this case step 336 scans the electronic program guide for any unflagged programs in the series that is to be recorded. Alternatively, unrecorded episodes may be found by looking for episodes that are both unrecorded and which have a current copyright date and/or are denoted as repeats in the electronic program guide.

Once the programs to be recorded have been identified in the aforementioned manner, the method continues with step 338, which determines whether two or more of the programs to be recorded are to be broadcast in whole or in part at the same time, thus presenting a scheduling conflict. If no conflicts are found, the method proceeds to step 346 in which the program is scheduled for recording. On the other hand, if a conflict between the broadcast times of two programs is found, then step 344 establishes searching criteria that can be used to scan the electronic program guide 80 to determine if one or both of the conflicting programs are scheduled to be rebroadcast at a later time or date. Such criteria will typically be a unique program identifier embedded in the program guide data, a program title, or any other suitable criteria. This criteria is used in step 320 to scan the electronic program guide for any matches. If a match is in fact found for at least one of the conflicting programs, then after determining that the time of the rebroadcast program does not present any scheduling conflicts, the processor 70 reschedules the recording of the program being rebroadcast for the later time. The remaining program that gave rise to the scheduling conflict may then be scheduled by step 346 for recording at the time that was originally determined since it would no longer conflict with another program. That is, recording of the program that will be rebroadcast is postponed until the time of the rebroadcast, whereas recording of the program that is not scheduled for rebroadcast can be recorded at its original time.

Once the program or programs have been scheduled for recording by step 346, the process proceeds to step 350 which at the appropriate time tunes the channel and/or otherwise outputs the matching content to the storage device. For example, the control unit 70 controls the receiver/tuner 40 to tune the channel of the available content spectrum to the appropriate channel. Then, the switch 50 is controlled by control unit 70 to switch the tuned channel to be fed to the storage device 200. The storage device 200 may then record the routed content.

Once the content has been recorded by storage device 200, step 360 then updates a file manager that may be part of the storage device 250, the control unit 70, other elements of the apparatus 100, or a separate entity. Essentially, the recorded content is stored as a file or files within the storage device 200. These file(s) have an associated address or header information that is managed by the file manager. Step 360 updates the file manager with information related to the recorded content.

By using the file manager, the user can then manage the recorded content with step 370. Specifically, the managing of the recorded content includes sorting, cataloging, adding comments, deleting, reorganizing, etc. Such management may also include on-demand playback. Such playback includes various commands including play, rewind, fast forward, pause, slow, skip, and the like.

1. A method for recording at least one program received over a broadband communications system, said method comprising the steps of:
accessing a database that includes program information describing with program attributes a plurality of programs available over the broadband communications system;
receiving user-defined criteria identifying preferred program attributes;
sorting through the database to identify at least one preferred program having program attributes that include the preferred program attributes;
identifying from information in the database a first scheduled time at which the preferred program is to be received;
comparing the first scheduled time to another scheduled time of another program to be recorded;
if said first scheduled time and said another scheduled time overlap in whole or in part thereby giving rise to a scheduling conflict, sorting through the database to identify a second scheduled time at which either the preferred program or said another program is available;
scheduling recording at the second scheduled time of either the preferred program or said another program that is available at the second scheduled time; and
scheduling recording of a remaining one of the preferred program or said another program at the first scheduled time or said another scheduled time, respectively.

2. The method of claim 1 wherein said another program to be recorded is identified simultaneously with the preferred program.

3. The method of claim 1 wherein said another program to be recorded has been scheduled for recording prior to identifying the preferred program.

4. The method of claim 1 wherein said database is an electronic program guide.

5. The method of claim 1 wherein the identifying, comparing and scheduling steps are performed by a digital video recorder.

6. The method of claim 1 wherein the identifying, comparing and scheduling steps are performed by a set-top terminal that incorporates a digital video recorder.

7. The method of claim 1 further comprising the steps:
determining if the preferred program is an episode in a series of related programs to be recorded;
sorting through the database to identify any unrecorded episodes of the series of related programs that have been previously made available over the broadband communications system;
identifying from information in the database other scheduled times at which one or more of the unrecorded, previously available episodes will again be available; and
scheduling recording of said one or more of the unrecorded, previously available episodes at one of the other scheduled times.

8. A method for recording at least one program received over a broadband communications system, said method comprising the steps of:
accessing a database that includes program information describing with program attributes a plurality of programs available over the broadband communications system;
receiving user-defined criteria identifying preferred program attributes;
sorting through the database to identify at least one preferred program having program attributes that include the preferred program attributes;
identifying from information in the database a first scheduled time at which the preferred program is to be received;
scheduling recording of the preferred program at the first scheduled time;
determining if the preferred program is an episode in a series of related programs to be recorded;
sorting through the database to identify any unrecorded episodes of the series of related programs that have been previously made available over the broadband communications system;
identifying from information in the database other scheduled times at which one or more of the unrecorded, previously available episodes will again be available; and
scheduling recording of said one or more of the unrecorded, previously available episodes at one of the other scheduled times.

9. The method of claim 8 further comprising the steps of:
identifying from information in the database a first scheduled time at which the preferred program is to be received;
comparing the first scheduled time to another scheduled time of another program to be recorded;
if said first scheduled time and said another schedule time overlap in whole or in part thereby giving rise to a scheduling conflict, sorting through the database to identify a second scheduled time at which either the preferred program of said another program is available;
scheduling recording at the second scheduled time of either the preferred program or said another program that is available at the second scheduled time; and
scheduling recording of a remaining one of the preferred program or said another program at the first scheduled time or said another scheduled time, respectively.

10. The method of claim 9 wherein said another program to be recorded is identified simultaneously with the preferred program.

11. The method of claim 9 wherein said another program to be recorded has been scheduled for recording prior to identifying the preferred program.

12. The method of claim 8 wherein said database is an electronic program guide.

13. The method of claim 8 wherein the identifying, comparing and scheduling steps are performed by a digital video recorder.

14. The method of claim 8 wherein the identifying, comparing and scheduling steps are performed by a set-top box that incorporates a digital video recorder.

15. An apparatus comprising:
a receiver/tuner 40 for receiving programming content over a broadband communications system;
a decoder 60 for decoding programming content provided by the receiver/tuner;
an electronic storage device 200 for electronically storing selected content received over the broadband communications system;
a database 80 to which an electronic program guide is periodically downloaded from a remote location;
a control unit 70 operationally associated with the receiver/tuner, the decoder, the electronic storage device and the database;
a user interface 90 operationally associated with at least the control unit and the database;
wherein said control unit is configured to (i) determine whether a scheduling conflict arises between or among two or more programs to be received over the broadband communications system and scheduled for recording onto the electronic storage device via the user interface; (ii) identify in the database another time at which one of said two or more programs will be available for receipt over the broadband communications system; and (iii) reschedule for recording at said another time the one program that will be available at said another time.

16. The apparatus of claim 15 wherein said control unit 70 is further configured to (i) determine if a program to be received over the broadband communications system 100 and scheduled for recording onto the electronic storage device 200 via the user interface 90 is an episode in a series of related programs to be recorded; (ii) identify in the database any unrecorded episodes of the series of relates programs that have been previously made available over the broadband communications system and which will subsequently be available at other times over the broadband communications system; and (iii) schedule for recording at at least one of said other times at least one of the previously available, unrecorded programs.

17. An apparatus comprising:
a receiver/tuner 40 for receiving programming content over a broadband communications system;
a decoder 60 for decoding programming content provided by the receiver/tuner;
an electronic storage device 200 for electronically storing selected content received over the broadband communications system;
a database 80 to which an electronic program guide is periodically downloaded from a remote location;
a control unit 70 operationally associated with the receiver/tuner, the decoder, the electronic storage device and the database;
a user interface 90 operationally associated with at least the control unit and the database;
wherein said control unit 70 is configured to (i) determine if a program to be received over the broadband communications system and scheduled for recording onto the electronic storage device via the user interface is an episode in a series of related programs to be recorded; (ii) identify in the database any unrecorded episodes of the series of relates programs that have been previously made available over the broadband communications system and which will subsequently be available at other times over the broadband communications system; and (iii) schedule for recording at at least one of said other times at least one of the previously available, unrecorded programs.

18. The apparatus of claim 17 wherein said control unit 70 is further configured to (i) determine whether a scheduling conflict arises between or among two or more programs to be received over the broadband communications system and scheduled for recording onto the electronic storage device via the user interface; (ii) identify in the database another time at which one of said two or more programs will be available for receipt over the broadband communications system; and (iii) reschedule for recording at said another time the one program that will be available at said another time.
